(19) United States
(12) Patent Application Publication
(10) Pub. No.: US 2023/0202883 A1
(43) Pub. Date: Jun. 29, 2023

(54) METHOD AND APPARATUS FOR THE SIMULTANEOUS PRODUCTION OF HYDROGEN BASED ENERGY AND CLEAN WATER FROM A SALINE OR CONTAMINATED WATER SOURCE

(71) Applicant: VRM International Pty Ltd, Garbutt (AU)

(72) Inventor: Kenneth Michael BELLAMY, Garbutt (AU)

(21) Appl. No.: 17/560,484

(22) Filed: Dec. 23, 2021

(51) Int. Cl. C02F 1/461; C02F 1/44; F02G 5/02

(52) U.S. Cl. CPC C02F 1/46104; C02F 1/44; F02G 5/02; C02F 2103/08

(57) ABSTRACT

A method for producing clean water from a contaminated water source, the method comprising the steps of: a) locating a clean water generating device in fluid communication with the contaminated water source, the clean water generating device including a reaction chamber containing an ionic solution; b) transferring contaminated water from the contaminated water source into the reaction chamber through an inlet in the clean water generating device; c) generating an electrolysis reaction within the reaction chamber; d) removing gas generated by the electrolysis reaction from the reaction chamber through an outlet of the reaction chamber; e) combusting the gas generated by the electrolysis reaction; and f) collecting clean water generated by the combustion of the gas.

### TECHNICAL FIELD

The present invention relates to a method and apparatus for producing clean water and energy. In particular, the present invention relates to a method and apparatus for producing clean water from a contaminated or saline body of water and renewable energy from a hydrogen generated hydrogen source.

### BACKGROUND

A lack of access to clean water is an increasing issue in many parts of the world, and particularly in the developing world. Lack of access to safe water sources is a leading risk factor for infectious diseases such as cholera, diarrhoea, dysentery, hepatitis A, typhoid and polio. It also exacerbates malnutrition and especially childhood stunting.

In addition, a lack of access to clean water impact negatively on agriculture, both in terms of the quantity and quality of crops and livestock produced.

Some processes, including desalination and wastewater recycling, have been made to produce clean water from contaminated or saline water. However, desalination is a highly energy-intensive process, and wastewater recycling has struggled to find acceptance in some parts of the world.

Thus, there would be an advantage if it were possible to provide a relatively low-energy method for producing clean water. There would be a further advantage if it were possible to simultaneously provide for the generation of a clean and renewable energy source.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a method and apparatus for producing clean water which may at least partially address one or more of the problems or deficiencies mentioned above or which may provide the public with a useful or commercial choice.

With the foregoing in view, in a first aspect the present invention resides broadly in a method for producing clean water from a contaminated water source, the method comprising the steps of:
a) Locating a clean water generating device in fluid communication with the contaminated water source, the clean water generating device including a reaction chamber containing an ionic solution;
b) Transferring water from the contaminated water source into the reaction chamber through an inlet in the clean water generating device;
c) Generating an electrolysis reaction within the reaction chamber;
d) Removing gas generated by the electrolysis reaction from the reaction chamber through an outlet therein;
e) Combusting the gas generated by the electrolysis reaction; and
f) Collecting clean water generated by the combustion of the gas.

It will be understood that, in the context of the present invention, the term “contaminated water” may refer to water that has been contaminated with any suitable chemical or biological contaminant, thereby making the contaminated water unsuitable for consumption or use by humans and/or unsuitable for use in agriculture, food and beverage manufacture and so on. It will be understood that the term “contaminated water” is intended to include saltwater (such as sea water) within its scope.

It will be understood that, in the context of the present invention, the term “clean water” may refer to water from which sufficient chemical or biological contaminants have been removed, thereby the clean water suitable for consumption or use by humans and/or suitable for use in agriculture, food and beverage manufacture and so on. While water having relatively high purity is intended to be included within the scope of the term “clean water”, the term is not intended to be limited to this meaning.

The contaminated water source may be of any suitable type. Preferably, however, the contaminated water source may comprise a body of water, such as an ocean, lake, river, stream, creek, dam, pond, reservoir, tank, pool or the like. The body of water may comprise a naturally-occurring body of water or may comprise a man-made body of water.

The contaminated water source may be contaminated by any suitable contaminants. For example, the contaminated water source may be contaminated by one or more chemical and/or biological contaminants. The contaminants may be naturally-occurring within the contaminated water source (such as salt in sea water) or may have been added to the contaminated water source intentionally (for instance, the addition of chlorine to a swimming pool), unintentionally (such as in the case of a chemical leak or spill) or may have been added through an industrial process (such as through the use of chemicals and reagents in manufacturing, mining or agricultural processes and the like).

In a preferred embodiment of the invention, the contaminants may be chemical contaminants. In particular, the contaminants may comprise molecular contaminants.

The clean water generating device may be of any suitable size, shape of configuration, and it will be understood that the size of the clean water generating device my vary depending on the size or volume of the contaminated water source, and the desired volume of clean water to be produced.

As previously stated, the clean water generating device is located in fluid communication with the contaminated water source. In particular, at least a portion of the clean water generating device is located in fluid communication with the contaminated water source. More specifically, at least a lower surface of the clean water generating device is located in fluid communication with the contaminated water source. In this embodiment of the invention, it is envisaged that the inlet may be located in the lower surface of the clean water generating device.

In some embodiments of the invention, the clean water generating device may be configured to float on the surface of the contaminated water source. In other embodiments of the invention, the clean water generating device may be at least partially submerged within the contaminated water source.

In a preferred embodiment, the clean water generating device may be provided with one or more stabilising members. The stabilising members may be of any suitable form, and may include one or more flotation members, one or more weighted members (such as ballast or the like), one or more anchoring members or the like, or any suitable combination thereof. Preferably, the one or more stabilising members may be configured to retain the clean water generating device (and, more specifically, the inlet of the clean water generating device) in fluid communication with the contaminated water source. The one or more stabilising members may also be configured to retain the clean water generating device in place on or within the contaminated water source.

As previously stated, the clean water generating device includes a reaction chamber. Preferably, the reaction chamber is located internally to the clean water generating device. The reaction chamber may comprise a portion of the interior of the clean water generating device, or may comprise substantially the entire interior of the clean water generating device. In use, the reaction chamber contains an ionic solution. Preferably, the ionic solution is an aqueous ionic solution.

The ionic solution may be of any suitable form. In a preferred embodiment, the ionic solution may comprise a solution of one or more soluble ionic compounds in water. The one or more soluble ionic compounds may be of any suitable form, and may comprise one or more salts (such as an ammonium, potassium or sodium salt), bromides, chlorides, iodides, acetates, nitrates, sulfates or the like, or any suitable combination thereof.

Any suitable concentration of the soluble ionic compounds in the solution within the reaction chamber may be used. Preferably, however, the concentration of the soluble ionic compounds in the solution may be greater than the concentration of contaminants in the contaminated water source. Thus, the concentration of the soluble ionic compound in the solution may vary depending on the nature of the contaminated water source. In a preferred embodiment of the invention, however, the concentration of the soluble ionic compound in the solution may comprise at least 2% w/w. More preferably, the concentration of the soluble ionic compound in the solution may comprise at least 3% w/w. Still more preferably, the concentration of the soluble ionic compound in the solution may comprise at least 4% w/w. Yet more preferably, the concentration of the soluble ionic compound in the solution may comprise at least 5% w/w.

The transfer of contaminated water into the reaction chamber through the inlet may be achieved using any suitable technique. For instance, the inlet may comprise an aperture through which contaminated water may flow. Alternatively, a flow of contaminated water may be directed into the inlet of the clean water generating device.

More preferably, one or more filters may be associated with the inlet. Preferably, the one or more filters substantially cover the inlet. The one or more filters may be of any suitable form, although in a preferred embodiment of the invention, the one or more filters may comprise membrane filters, and, in particular, osmotic membrane filters. Any suitable membrane filter may be used, such as a porous membrane, a nonporous polymeric membrane or a mixed matrix membrane.

Preferably, the membrane filters of the present invention may be fabricated from cellulose acetates, polyamides, polyimides, and poly-sulfones or any suitable combination thereof. In another embodiment of the invention, the membrane filters may be fabricated from a natural substance, such as animal skin or the like.

In a preferred embodiment of the invention, one or more stiffening members may be associated with the one or more membrane filters. The one or more stiffening members may be of any suitable form, although it is envisaged that the one or more stiffening members may be configured to reduce or eliminate the possibility of the one or more membrane filters from becoming disengaged from the inlet. In a preferred embodiment of the invention, the one or more stiffening members may comprise a mesh material associated with the one or more membrane filters and/or the inlet. Any suitable mesh material may be provided, although in a preferred embodiment the mesh material may comprise a metal mesh and, in particularly, a relatively inflexible metal mesh. The mesh material may be located between the contaminated water source and the one or more membrane filters, or may be located between the one or more membrane filters and the reaction chamber. In some embodiments, a piece of mesh material may be located on either side of the one or more membrane filters.

It is envisaged that, by providing the ionic solution in the reaction chamber with a higher concentration of ionic soluble matter than the contaminated water, water from the contaminated water source may flow into the reaction chamber through the one or more filters covering the inlet by osmosis. It is envisaged that the water that flows into the reaction chamber may be relatively free of contaminants.

The electrolysis reaction may be generated in the reaction chamber using any suitable technique. Preferably, however, one or more electrodes are located within the reaction chamber, the one or more electrodes being configured to generate the electrolysis reaction. In a particular embodiment, the one or more electrodes may comprise one or more anodes and one or more cathodes.

In a preferred embodiment of the invention, the one or more anodes and the one or more cathodes may be electrically associated with a source of electrical power. The source of electrical power may be of any suitable form, and may comprise mains power, a generator, one or more batteries or the like. More preferably, however, the one or more anodes and one or more cathodes may be electrically associated with one or more photovoltaic cells. The one or more photovoltaic cells may be located remotely to the clean water generating device and electrically connected thereto via one or more leads, cables or the like. Alternatively, however, the one or more photovoltaic cells may be configured for attachment to the clean water generating device. In a particular embodiment of the invention, the one or more photovoltaic cells may be mounted to an external surface of the clean water generating device.

It is envisaged that actuation of the source of electrical power may drive the electrolysis reaction within the reaction chamber.

As electrolysis takes place, the temperature of the ionic solution within the reaction chamber may increase. In order to reduce or eliminate the possibility of the ionic solution boiling (and the volatilisation of any ionic matter within the solution) it is envisaged that the source of electrical power may be configured to turn off when the ionic solution reaches or exceeds a predetermined temperature. Thus, one or more temperature sensors may be provided. Any suitable predetermined temperature may be selected, although in a preferred embodiment of the invention the predetermined temperature may be between 70° C. and 99° C. More preferably, the predetermined temperature may be between 80° C. and 97° C. Still more preferably, the predetermined temperature may be between 85° C. and 95° C. Most preferably, the predetermined temperature may be approximately 90° C.

In some embodiments of the invention, one or more heat transfer devices may be associated with the clean water generating device. In particular, one or more heat transfer devices may be associated with the reaction chamber. In this embodiment, the one or more heat transfer devices may be provided in order to extract thermal energy from the reaction chamber for capture and/or use. Any suitable heat transfer device may be used, although in a preferred embodiment of the invention the heat transfer device may comprise a heat exchanger. Any suitable heat exchange fluid may be used in the heat exchanger.

During the electrolysis reaction, oxygen may be produced at the one or more anodes, and hydrogen may be produced at the one or more cathodes. It is envisaged that the oxygen and hydrogen produced during the electrolysis reaction will be in the form of gaseous oxygen and gaseous hydrogen. Typically, twice as much hydrogen as oxygen will be produced in the electrolysis reaction. In this embodiment of the invention, the oxygen and hydrogen produced during the electrolysis reaction may rise within the reaction chamber and exit the reaction chamber through the outlet. Thus, the outlet may be provided in an upper portion of the reaction chamber.

The reaction chamber may be of any suitable shape. However, in a preferred embodiment of the invention, the cross-sectional area of the reaction chamber adjacent the inlet may be greater than the cross-sectional area of the reaction chamber adjacent the outlet. Thus, the reaction chamber may taper between the lower portion thereof and the upper portion thereof. The reaction chamber may taper continuously between the lower portion thereof and the upper portion thereof, or may comprise two or more sections having different geometry to one another. In a preferred embodiment of the invention, at least an upper portion of the reaction chamber may be in the shape of a truncated cone.

Preferably, a lower portion of the reaction chamber may be substantially cylindrical having any suitable cross-sectional shape (e.g. circular, square, rectangular or the like) while an upper portion of the reaction chamber may be provided with a truncated conical shape. In this embodiment of the invention, it is envisaged that the one or more anodes and one or more cathodes may be located substantially within the lower portion of the reaction chamber.

It is envisaged that, by providing an upper portion of the reaction chamber that has a smaller cross-sectional area than the lower portion of the reaction chamber, oxygen and hydrogen gas (i.e. oxyhydrogen gas) that is generated by the electrolysis reaction may be directed towards the outlet of the reaction chamber.

The outlet may be of any suitable form. Preferably, however, the outlet is substantially covered by one or more filters. Any suitable filters may be provided, although in a preferred embodiment of the invention the one or more filters may comprise gas-permeable membranes. Any suitable gas-permeable membranes may be used, such as, but not limited to, silicone or polydimethylsiloxane (PDMS) membranes, or geotextile membranes fabricated from polypropylene, polyester or the like.

It is envisaged that the one or more filters associated with the outlet may be configured to permit the flow of gas therethrough, but to substantially preclude the flow of liquid therethrough. Thus, in a preferred embodiment of the invention, gas produced by the electrolysis reaction is permitted to pass through the one or more filters. It is envisaged that the transfer of gas through the one or more filters may be driven by the pressure in the reaction chamber.

In a preferred embodiment of the invention, one or more stiffening members may be associated with the one or more filters. The one or more stiffening members may be of any suitable form, although it is envisaged that the one or more stiffening members may be configured to reduce or eliminate the possibility of the one or more filters from becoming disengaged from the outlet. In a preferred embodiment of the invention, the one or more stiffening members may comprise a mesh material associated with the one or more filters and/or the outlet. Any suitable mesh material may be provided, although in a preferred embodiment the mesh material may comprise a metal mesh and, in particularly, a relatively inflexible metal mesh. The mesh material may be located between the reaction chamber and the one or more filters, or may be located between the one or more filters and a conduit configured to transfer gas away from the reaction chamber. In some embodiments, a piece of mesh material may be located on either side of the one or more filters.

In a preferred embodiment of the invention, the clean water generating device further comprises a gas combustion portion. The gas combustion portion may be of any suitable form, although it is envisaged that the gas combustion portion may be configured to combust the gas generated in the reaction chamber.

The gas combustion portion may be configured to combust the gas as it passes through the one or more filters at the outlet of the reaction chamber. More preferably, the gas combustion portion may be spaced apart from the reaction chamber and gas may be transferred from the reaction chamber to the gas combustion portion.

The gas may be transferred using any suitable technique. Preferably, however, the gas flows through one or more conduits between the reaction chamber and the gas combustion portion. The one or more conduits may be of any suitable size, shape or configuration, and it will be understood that the size and configuration of the one or more conduits may be determined by factors such as the size of the reaction chamber, the quantity of gas produced and so on.

In a preferred embodiment of the invention, the one or more conduits may comprise hoses, pipes and the like extending between the reaction chamber and the gas combustion portion. In a preferred embodiment of the invention, the conduit may be closed at both ends. Thus, in this embodiment of the invention, the conduit may be maintained at an elevated pressure. The conduit may be maintained at any suitable elevated pressure. For instance, the conduit may be maintained at a pressure of up to 20 atm. More preferably, the conduit may be maintained at a pressure of up to 10 atm. Still more preferably, the conduit may be maintained at a pressure of up to 5 atm. Yet more preferably, the conduit may be maintained at a pressure of up to 2 atm. It is envisaged that the pressure in the reaction chamber and the pressure in the conduit may be substantially the same.

Preferably, one or more valves may be located within the conduit. The valves may be of any suitable form, although in a preferred embodiment of the invention the one or more valves may be configured to substantially preclude the flow of gas from the conduit into the reaction chamber. Thus, the one or more valves may comprise non-return valves (also referred to as one-way valves or check valves). The one or more valves may be located at any suitable position within the conduit, although in a preferred embodiment may be located in relatively close proximity to the one or more filters.

In some embodiments, one or more gas storage vessels may be provided. The gas storage vessels may be configured to store gas produced in the reaction chamber. Gas may be stored in the one or more gas storage vessels under certain circumstances, such as if the rate of gas production in the chamber exceeds the rate at which gas can be combusted in the gas combustion portion, the gas combustion portion is offline for maintenance or repair, if there is a reduced need for clean water generated by the clean water generating device and so on.

The one or more gas storage vessels may be of any suitable form, and may comprise one or more tanks, cylinders, pressure vessels or the like, or any suitable combination thereof.

The gas combustion portion may be of any suitable form. Preferably, the gas combustion portion may be sealed to the atmosphere to prevent the ingress of other gases and the formation of unwanted combustion products. It is envisaged that hydrogen and oxygen gas transferred from the reaction chamber and/or the one or more gas storage vessels may be introduced to the gas combustion portion and combusted. The gas may be combusted at any suitable temperature, although it will be understood that the temperature at which the gas is combusted must be at least the autoignition temperature of oxyhydrogen gas (i.e. 570° C. at 1 atm pressure). Preferably, the flowrate of oxyhydrogen gas into the combustion portion may be controlled to ensure complete combustion of the gas entering the gas combustion portion.

The heat required to combust the gas in the gas combustion portion may be obtained from any suitable source. For instance, a fuel (such as natural gas or similar hydrocarbon) may be combusted to generate the required combustion temperature in the gas combustion portion. Alternatively, electricity may be used to create the desired combustion conditions within the gas combustion portion. In a preferred embodiment of the invention, the electricity used to create the desired combustion conditions within the gas combustion portion may be generated by the one or more photovoltaic cells associated with the clean water generating device. In another embodiment, the electricity to create the desired combustion conditions within the gas combustion portion may be generated by one or more fuel cells.

It will be understood that the combustion of oxyhydrogen gas need not necessarily require the use of elevated temperatures (such as those generated by a flame or the like), elevated pressures or a combination of elevated temperatures and pressures. Instead, the combustion of oxyhydrogen may be achieved using relatively low-intensity ignition sources, such as a pilot light, spark or the like. It is envisaged that a spark may be generated using any suitable technique, such as striking a flint, using piezoelectric materials and the like.

In a preferred embodiment of the invention, the gas combustion portion may comprise a sealed portion (such as a sealed chamber, sealed housing or the like). In this embodiment of the invention, the gas combustion portion may be maintained at an elevated pressure. The gas combustion portion may be maintained at any suitable elevated pressure. For instance, the gas combustion portion may be maintained at a pressure of up to 20 atm. More preferably, the gas combustion portion may be maintained at a pressure of up to 10 atm. Still more preferably, the gas combustion portion may be maintained at a pressure of up to 5 atm. Yet more preferably, the gas combustion portion may be maintained at a pressure of up to 2 atm. It is envisaged that the pressure in the conduit may be substantially the same as the pressure in the gas combustion portion.

It will be understood that the one or more conduits may be of any suitable length. In some embodiments, the one or more conduits may be relatively short, so that the gas combustion portion is located relatively close to the clean water generating device. In this embodiment, it is envisaged that the clean water generating device may be configured to be located on a body of water, and the gas combustion portion may also be located on the body of water (for instance on a pontoon, vessel or the like). In an alternative embodiment, the one or more conduits may be relatively long, such that the gas combustion portion may be located relatively remote to the clean water generating device. In this embodiment, it is envisaged that the gas combustion portion may be located on land (and preferably land adjacent or relatively close to the body of water on which the clean water generating device is located). Thus, the one or more conduits may extend relatively long distances between the clean water generating device and the gas combustion portion.

In some embodiments of the invention, the device may be provided with one or more pressure release valves. The pressure release valves may be located at any suitable location. For instance, the pressure release valves may be associated with the reaction chamber, the conduit, the gas combustion portion or any suitable combination thereof.

It is envisaged that the combustion products from the combustion of oxygen and hydrogen will be water (and particularly clean water) and energy in the form of heat. Thus, the clean water generating device may further comprise a clean water collection portion. The clean water collection portion may be of any suitable form, and may comprise one or more tanks, ponds, or the like, or any suitable combination thereof.

Energy in the form of heat generated by the combustion of the gas may be captured by one or more heat transfer devices. In this embodiment, the one or more heat transfer devices may be provided in order to extract thermal energy from the gas combustion portion for capture and/or use. Any suitable heat transfer device may be used, although in a preferred embodiment of the invention the heat transfer device may comprise a heat exchanger. Any suitable heat exchange fluid may be used in the heat exchanger.

In other embodiments of the invention, heat generated by the combustion of the gas may be used to drive one or more devices. Any suitable devices may be driven by the heat generated by the combustion of the gas. For instance, heat generated by the combustion of the gas may be used to drive one or more turbines, motors or the like.

In some embodiments of the invention, heat captured by the one or more heat transfer devices may be used to maintain the gas combustion portion at the desired combustion temperature.

In a second aspect, the invention resides broadly in a clean water generating device for generating clean water from a contaminated water source, comprising:
An inlet configured to be placed in fluid communication with the contaminated water source;
A reaction chamber configured to contain an ionic solution and to receive contaminated water from the contaminated water source, the reaction chamber including one or more electrodes configured to generate an electrolysis reaction within the reaction chamber;
An outlet configured to permit gas generated by the electrolysis reaction to leave the reaction chamber; and
A gas combustion portion configured to combust the gas generated by the electrolysis reaction to generate clean water.

The present invention provides numerous advantages over the prior art. Firstly, the present invention provides a relatively low-energy method for generating clean water from a contaminated water source. Further, the present produces relatively pure water in comparison to existing processes such as desalination, making the clean water produced by the present invention suitable for a wider array of purposes.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 illustrates a schematic view of a clean water generating device according to an embodiment of the present invention.

### DETAILED DESCRIPTION

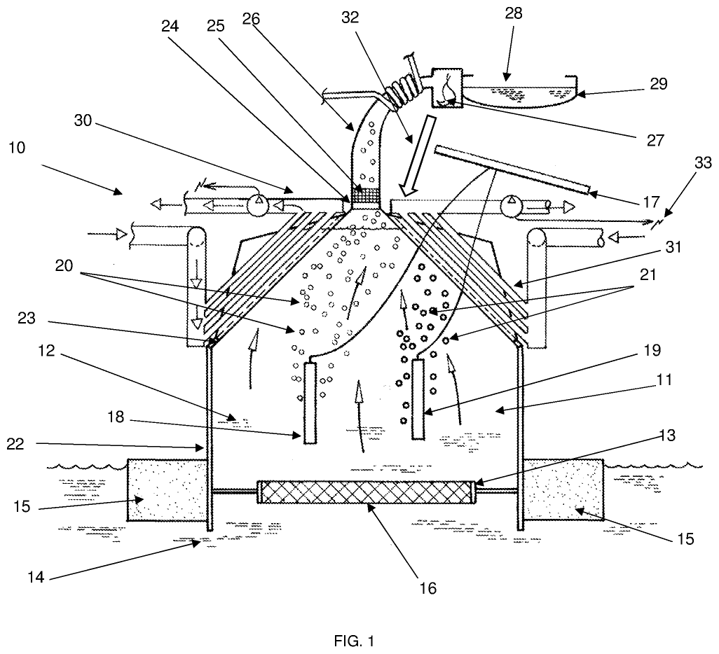

FIG. 1 illustrates a schematic view of a clean water generating device 10 according to an embodiment of the present invention. The device 10 includes a reaction chamber 11 located within the device 10 and containing an ionic solution 12.

The device 10 includes an inlet 13 located in a lower surface thereof. The inlet 13 is configured to be located in fluid communication with a contaminated water source 14. In the embodiment of the invention shown in FIG. 1, the device is configured to be retained partially submerged within the contaminated water source 14 through the use of ballast 15.

The reaction chamber 11 comprises a lower cylindrical portion 22 and an upper truncated conical portion 23.

The inlet 13 is provided with one or more osmotic membrane filters 16 that extend across the entire inlet 13. In this way, water from the contaminated water source 14 may flow into the reaction chamber 11 through the osmotic membrane filters 16 by osmosis.

A photovoltaic cell 17 is associated with an outer surface of the device 10, with the photovoltaic cell 17 being electrically connected to an anode 18 and a cathode 19 located within the reaction chamber 11. Electricity generated by the photovoltaic cell 17 flows to the anode 18 and the cathode 19 to generate an electrolysis reaction within the reaction chamber 11. In particular, oxygen is generated at the anode 18 and hydrogen is generated at the cathode 19. Oxygen bubbles 20 and hydrogen bubbles 21 rise within the ionic solution 12 and are funnelled towards the outlet 24 of the reaction chamber 11 due to the truncated conical shape of the upper portion 23 of the reaction chamber 11.

The outlet 24 of the reaction chamber is covered by a gas permeable membrane 25 that permits the flow of oxygen 20 and hydrogen 21 therethrough, but substantially precludes the flow of liquid therethrough.

Gas that passes through the membrane 25 flow along a conduit 26 to a gas combustion portion 27. In the gas combustion portion 27, the gas is combusted to generate combustion products in the form of water 28 and heat. The water 28 generated by combustion in the gas combustion portion 27 is collected in a water collection portion 29, such as a tank, pond, reservoir or the like.

It will be understood that the conduit 26 may be of any suitable length. Thus, the gas combustion portion 27 may be located relatively close to the clean water generating device 10, or may be located relatively remotely to clean water generating device 10. Preferably, the clean water generating device 10 is located on the surface of a body of water, while the gas combustion portion 27 is located on an area of land relatively close to the body of water.

The device 10 is associated with a pair of heat exchangers 30, 31. The first heat exchanger 30 is located on an outer surface of the device 10 and is configured to extract heat from within the reaction chamber 11 so as to assist in keeping the temperature of the ionic solution 12 below its boiling point. The second heat exchanger 31 is used to extract energy from the heat 32 generated in the gas combustion portion 27.

Energy extracted from heat 32 using the heat exchangers 30, 31 may be used or stored for any suitable purpose. In some embodiments, at least a portion of the energy extracted by the heat exchangers 30, 31 may be converted to electricity and used to provide electricity to the gas combustion portion 27 and/or the anode 18 and cathode 19 and/or a device 33 (such as a motor, turbine or the like).

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method for producing clean water from a contaminated water source, the method comprising the steps of:
a) locating a clean water generating device in fluid communication with the contaminated water source, the clean water generating device including a reaction chamber containing an ionic solution;
b) transferring water from the contaminated water source into the reaction chamber through an inlet in the clean water generating device;
c) generating an electrolysis reaction within the reaction chamber;
d) removing gas generated by the electrolysis reaction from the reaction chamber through an outlet of the reaction chamber;
e) combusting the gas generated by the electrolysis reaction; and
f) collecting clean water generated by the combustion of the gas.

2. A method according to claim 1, wherein the contaminated water source comprises a naturally-occurring body of water or a man-made body of water.

3. A method according to claim 1, wherein contaminants in the contaminated water source comprise molecular contaminants.

4. A method according to claim 1, wherein the clean water generating device is configured to float on a surface of the contaminated water source or to be at least partially submerged within the contaminated water source.

5. A method according to claim 1, wherein the ionic solution in the reaction chamber includes soluble ionic compounds, and wherein a concentration of the soluble ionic compounds in the ionic solution is greater than a concentration of contaminants in the contaminated water source.

6. A method according to claim 1, wherein one or more osmotic membrane filters are associated with the inlet.

7. A method according to claim 6, wherein the water from the contaminated water source flows through the one or more osmotic membrane filters into the reaction chamber by osmosis.

8. A method according to claim 1, wherein one or more electrodes are located within the reaction chamber, the one or more electrodes being configured to generate the electrolysis reaction.

9. A method according to claim 1, wherein the gas removed from the reaction chamber through the outlet is transferred to a gas combustion portion.

10. A method according to claim 1, wherein the outlet is substantially covered by one or more gas-permeable membranes.

11. A method according to claim 1, wherein the removal of the gas through the outlet is driven by pressure in the reaction chamber.

12. A method according to claim 1, wherein the gas that passes through the outlet is transferred to a gas combustion portion via one or more conduits.

13. A method according to claim 12, wherein the one or more conduits are maintained at a pressure greater than atmospheric pressure.

14. A method according to claim 12, wherein the gas combustion portion comprises a sealed portion maintained at a pressure greater than atmospheric pressure.

15. A method according to claim 12, wherein combustion products from the combustion of the gas in the gas combustion portion comprise water and energy in the form of heat.

16. A method according to claim 15, wherein the water produced by the combustion of the gas is collected in a clean water collection portion.

17. A method according to claim 15, wherein the heat produced by the combustion of the gas is used to drive one or more turbines or motors.

18. A clean water generating device for generating clean water from a contaminated water source, comprising:
an inlet configured to be placed in fluid communication with the contaminated water source;
a reaction chamber configured to contain an ionic solution and to receive contaminated water from the contaminated water source, the reaction chamber including one or more electrodes configured to generate an electrolysis reaction within the reaction chamber;
an outlet configured to permit gas generated by the electrolysis reaction to leave the reaction chamber; and
a gas combustion portion configured to combust the gas generated by the electrolysis reaction to generate clean water.
